(19) United States
(12) Patent Application Publication
(10) Pub. No.: US 2021/0329436 A1
(43) Pub. Date: Oct. 21, 2021

(54) BLUETOOTH DEVICE NETWORKING SYSTEM AND METHOD BASED ON BLE

(71) Applicant: Bot3, Inc., Santa Clara, CA (US)

(72) Inventor: Chi-Min HUANG, Santa Clara, CA (US)

(21) Appl. No.: 16/851,964

(22) Filed: Apr. 17, 2020

(51) Int. Cl. H04W 4/80; H04W 84/18; H04W 8/00; H04W 88/04; H04W 40/24; H04L 12/26

(52) U.S. Cl. CPC H04W 4/80; H04W 84/18; H04L 43/10; H04W 88/04; H04W 40/246; H04W 8/005

(57) ABSTRACT

The present invention discloses a method of Bluetooth networking based on BLE-MESH Bluetooth network, comprising: sending heartbeat message to Bluetooth devices from a first Bluetooth device node in a Bluetooth network which embodied the Bluetooth device nodes, wherein said heartbeat message of the first Bluetooth device node includes address and attribute information of the first Bluetooth device; collecting and gathering heartbeat message of each Bluetooth device nodes; calculating a configuration plan of the Bluetooth network; and delivering network configuration information to related Bluetooth device node which is needed to be revised according to the configuration plan.

### TECHNICAL FIELD

The present invention relates to a kind of intelligent things, especially BLE (Bluetooth Low Energy) network technology field, and in particular relates to a Bluetooth device networking system and method based on BLE.

### BACKGROUND

With the development of internet of things, the Bluetooth MESH technology have a significant impact on the structure of Bluetooth network, configuration of node attribute and function of the whole network communication. The traditional method of Bluetooth equipment constructing network usually configure attribute of each node by hand, and configure all nodes into relay nodes, and cannot obtains the best networking plan, but it consumes the many power and materials.

At the same time, there are some limits between the Bluetooth device and the software license, for example, the computing power of the MCU in the Bluetooth device is not enough, and limits of the flash memory or the size of the Bluetooth communication package is limited, and so on.

In order to solve the problems as above, the present invention provides a system and method based on the BLE-MESH network to configure Bluetooth network and attribute of the node automatically. The present system and method can decrease time cost of the Bluetooth networking; network redundancy and load effectively, improve the speed of message communication, and enhance the stability of the network and save the cost.

### SUMMARY

The present invention discloses a method of Bluetooth networking based on BLE-MESH Bluetooth network, comprising: sending heartbeat message to Bluetooth devices from a first Bluetooth device node in a Bluetooth network which embodied the Bluetooth device nodes, wherein said heartbeat message of the first Bluetooth device node includes address and attribute information of the first Bluetooth device; collecting and gathering heartbeat message of each Bluetooth device nodes; calculating a configuration plan of the Bluetooth network; and delivering network configuration information to related Bluetooth device node which is needed to be revised according to the configuration plan.

The present invention also provides an intelligent networking system based on BLE-MESH Bluetooth network, comprising: a receive and send module, configured to send and receive heartbeat message between the Bluetooth device nodes; a process module, configured to calculate a configuration plan of the Bluetooth network based on the heartbeat message; a detect module, configured to detect if the configuration plan of the Bluetooth network is the best configuration plan of the Bluetooth network; and a adjustment module, configured to adjust information of the related Bluetooth device nodes based on the best configuration plan of the Bluetooth network.

Advantageously, in the present invention, the present system and method can decrease time cost of the Bluetooth networking; network redundancy and load effectively, improve the speed of message communication, and enhance the stability of the network and save the cost.

### BRIEF DESCRIPTION OF THE DRAWINGS

FIG. 1 illustrates a flowchart of Bluetooth networking based on BLE-MESH network according to one embodiment of the present invention.

FIG. 2 illustrates a detail flowchart of Bluetooth networking based on BLE-MESH network according to one embodiment of the present invention.

FIG. 3 illustrates a topography of the structure of a Bluetooth network in prior art before using method in present invention.

FIG. 4 illustrates a topography of the structure of a Bluetooth network based on BLE-MESH network according to one embodiment of the present invention

FIG. 5 illustrates a block diagram of a system based on BLE-MESH network according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

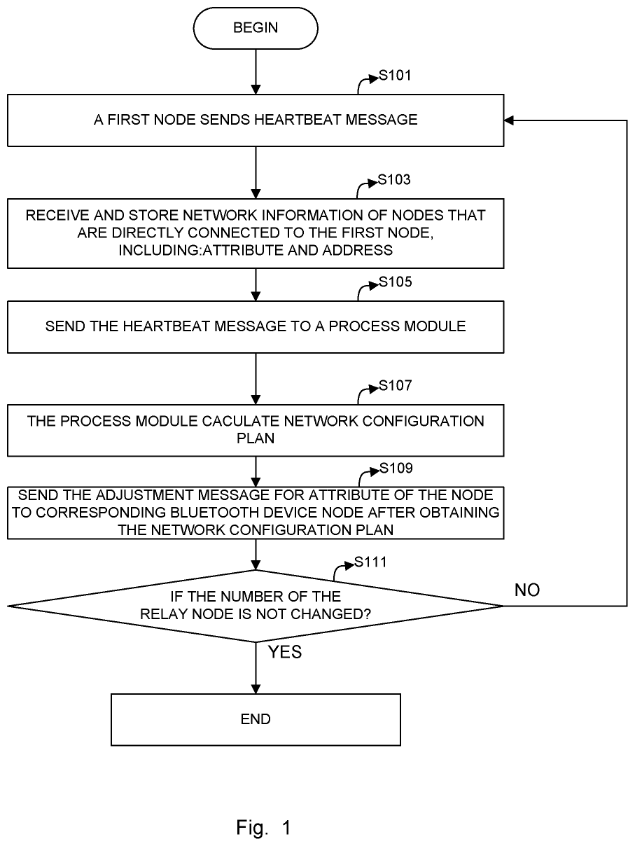

FIG. 1 illustrates a flowchart of Bluetooth networking based on BLE-MESH network according to one embodiment of the present invention. As shown in FIG. 1, take a Bluetooth device node in the Bluetooth network as an example, Step S101: a receive and send module in a first Bluetooth device sends heartbeat message to Bluetooth devices around the first Bluetooth device. The Bluetooth device herein can be a light with a Bluetooth chip, an earphone or other domestic appliances. Step S103: the heartbeat message that includes address and attributes information sends to a second Bluetooth device which is directly connected to the first Bluetooth device, specifically to a memory module and store into the memory module. The second Bluetooth device herein can be one or multiple Bluetooth devices. Specifically, the first Bluetooth device connects to the second Bluetooth device directly means that there is no relay node other kinds of node between the first Bluetooth device and the second Bluetooth device. Step S105: The heartbeat message stored in the memory module including attribute and address information is sent to a process module. The process module can be controller in the PC or smart phone in the intelligent platform. Step S107: the process module trains topological structure samples of the Bluetooth network by applying deep neural network model according to the heartbeat message, and extract topological structure prediction model, and calculate a network configuration plan. Step S109: a adjustment module in the intelligent platform obtains the configuration of the Bluetooth device node after obtaining the network configuration plan, i.e., the configuration that need to be revised. And the adjustment module sends the attribute adjustment information to corresponding Bluetooth device nodes. Specifically, the adjustment module can be Step S111: a detect module detects if the number of the prey nodes is same as the previous network configuration plan? If it is, ends the networking flowchart to obtain the best network configuration plan, i.e., the iterative calculation is ended; if not, Step 111 forward to Step S101 and will end the flowchart until obtain the best network configuration plan. According to the method disclosed above, the iteration of the network configuration is continued until the model converged to confirm the adjusted Bluetooth network is stable enough.

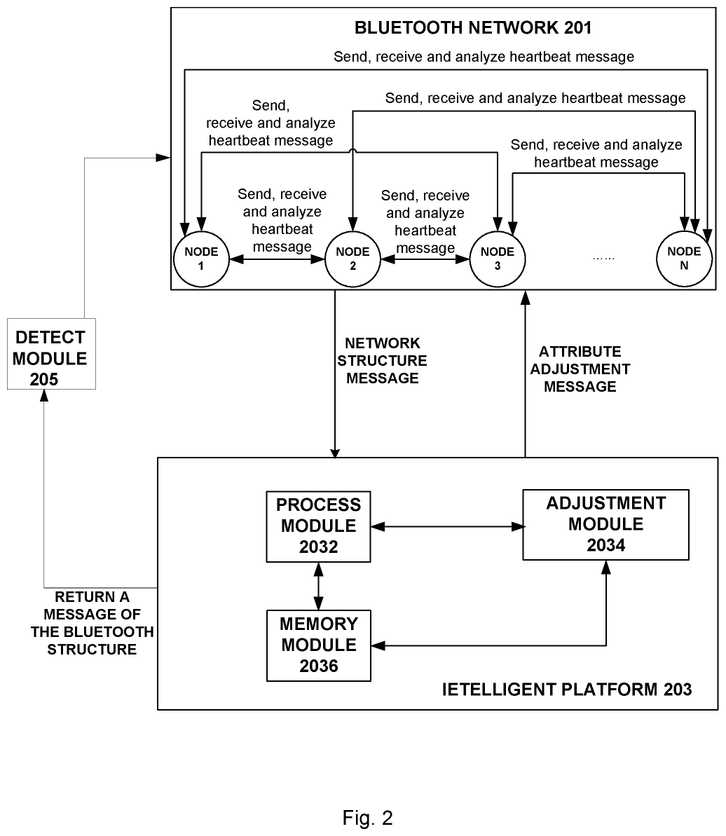

FIG. 2 illustrates a detail flowchart of Bluetooth networking based on BLE-MESH network according to one embodiment of the present invention. In one embodiment, as shown in FIG. 2, the Bluetooth network 201 includes multiple Bluetooth devices, or node 1, node 2 . . . node N for short; each node represents a Bluetooth device. Each node in the Bluetooth network 201 sends heartbeat message to other nodes and receives heartbeat message from other nodes. As shown in FIG. 2, the node 1 can sends heartbeat message of the node 1 to node 2, node 3 and node N, at the same time, the node 1 can receives heartbeat message of node 2, node 3 and node N. It should be understood that the connection between the nodes in FIG. 2 is an example, but is not limited. In one embodiment, each node analyses the heartbeat message from other nodes and organizes into network connection forms, and sends to intelligent platform 203 for proceeding. A process module 2032 in the intelligent platform 203 calculates network configuration plan of the nodes in the Bluetooth network 201, and sets up network structure and database system. To be specific, in order to avoid missing the Bluetooth device nodes from network structure and database system, the Bluetooth node information is forwarded or uses intelligent platform 203 to receive the whole Bluetooth network information. The method of forwarding Bluetooth node information is performed under the condition that the Bluetooth network system satisfies the basic functions of communication. In practice, the communication status of the Bluetooth network system may be not confirmed by the users, and the present invention disclosed above is suitable at any status. According to the embodiment of the present invention. As shown in FIG. 2, the method of structuring Bluetooth network structural database is based on a mobile intelligent platform, such as, a smart phone with a Bluetooth chip.

Further, as shown in FIG. 2, it describes a global network structural database formed by N numbers Bluetooth device notes (for example, Node 1, Node 2 . . . Node N). The technical person in the field should understand the example shown in FIG. 2 is not the limited for present invention. A network links form of each node in the Bluetooth network 201 includes an address and attribute information of each node and the nodes surrounding which are directed connect with the node. The connect information between the nodes are represented by function F(x,y), wherein the x represents node x, and y represents node y, and x is greater than y, i.e. x>y. As shown in below form, x represents a series of horizontal nodes, for example node 1, node 2 . . . node N, y represents a series of vertical nodes, for example node 2 . . . node N. The function F(x,y) means the connect information between node x and node y. For example, F(2,1) represents the connect information between node 2 and node 1, and the value of F(x,y) can be zero or one.

Form 1

| Node | 1 | 2 | 3 | . . . | N − 1 | N |
|---|---|---|---|---|---|---|
| 1 | M | F (2, 1) | F (3, 1) | . . . | F (N − 1, 1) | F (N, 1) |
| 2 | M | M | F (3, 2) | . . . | F (N − 1, 2) | F (N, 2) |
| 3 | M | M | M | . . . | F (N − 1, 3) | F (N, 3) |
| . . . | . . . | . . . | . . . | . . . | . . . | . . . |
| N − 1 | M | M | M | . . . | M | F (N, N − 1) |
| N | M | M | M | . . . | M | M |

As shown in above form, if the value of F(x,y) is equal to zero, it means that node x and node y is not connected, and the value of F(x,y) is equal to one, it means that node x and node y is connected directly. M represents Null. The connection information between the node 1 . . . node N in the Bluetooth network will be stored as form shown above. The form 1 shows the connect information between any two nodes, for example, connected directly or not connected directly.

In one example, the form that shows the connect information between each node will be sent to a process module 2032 in an intelligent platform 203. The process module 2032 will train the topological structure samples to extract topological forecast mode of the Bluetooth network by using depth neural network model, and then calculate the best Bluetooth network topological structure of the global network structural database by using the topological forecast module of the Bluetooth network, and further, the best network configuration plan will be obtained. Wherein the best Bluetooth network topological structure and the best network configuration plan is a structure and a plan that can be obtained by the present calculation method. Specifically, the Bluetooth network needs to gather a large amount of experimental data before obtaining the topological structure samples of the Bluetooth network that includes the number of the Bluetooth nodes in the samples, and the connection information between the Bluetooth nodes, and the attribute of the Bluetooth nodes. The topological forecast module of the Bluetooth network in present invention is a module document obtained by training amount of topological structure samples of the Bluetooth network. The best network configuration plan is calculated by topological forecast module and the best network topological structure chart which is obtained based on deep neural network model provided by TensorFlow, and then get the attribute and configuration information of each node, and the connection information of the nodes in the whole Bluetooth network. The best network configuration plan satisfies three criteria as below: the first criteria satisfy all the nodes in the Bluetooth network are connected with minimal relay nodes, the second criteria satisfy all the relay nodes are connected, and the third criteria satisfy that the number of the relay node remain constant during two successive configuration for the Bluetooth network. After the process module 2032 calculates and obtains the best network configuration, the configuration plan of the network will be sent as message to the adjustment module 2034; the adjustment module 2034 will adjust the address information and attribute information of the nodes according to the network configuration plan, and send the address information and attribute information of the nodes which need to be adjusted to the corresponding nodes for adjusting. The storage space for storing address information of each node to be adjusted takes two bytes, and the space for storing attribute information of each node to be adjusted takes one bytes. Each node will be calculated through optimization iteration to make the whole Bluetooth network stable.

Specifically, the method of optimization iteration calculating for each node is performed according to the flowchart in FIG. 1, includes performing all the steps in FIG. 1, and the optimization iteration calculating method will be ended until all the nodes in the Bluetooth network are connected with minimal relay nodes, and satisfy the criteria with the best network configuration plan which detects by the detect module 205. The detect module 205 will confirm if continue performing the steps in FIG. 1 based on the number of the relay nodes within two successive network configuration plans. In another words, when the number of the relay nodes within two successive network configuration plans is not changed, the Bluetooth network confirms the current network configuration plan belongs to the best network configuration plan, and then the current calculation steps for network configuration will be ended. At the same time, the whole network structural database of the N Bluetooth nodes created by the process module 2032 will be stored into the store module 2036 for using.

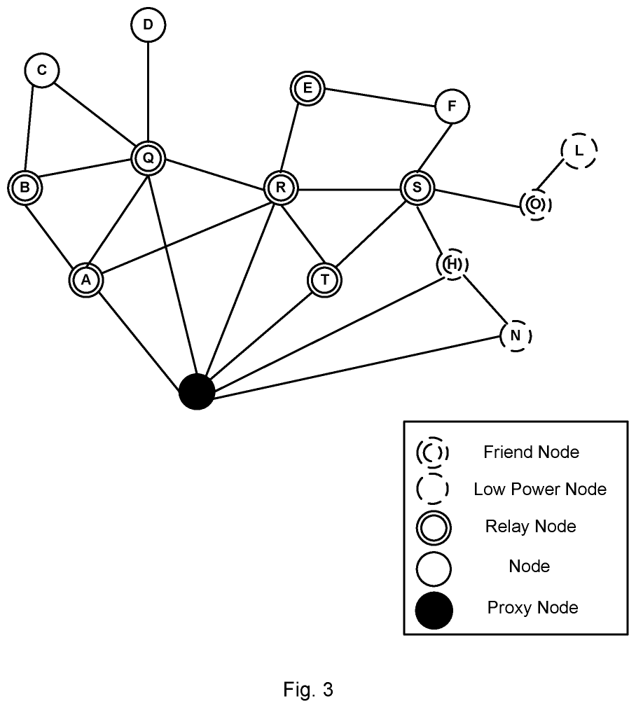

FIG. 3 shows a topography of the structure of a Bluetooth network in prior art before using method in present invention. As shown in FIG. 3, ◯ represents a Bluetooth device in a Bluetooth MESH network, is called Bluetooth node, can receive and send message. [symbol] represents a friend node, the friend node does not have power limits, and is suitable as friend node. The friend node is stored into LPN (Low Power Network), and is used to receive message and security update. When the LPN network requests to read the access information and the security update information, the friend node will transfer the stored information, i.e., the access information and the security update information to LPN network. [symbol] represents a relay node, which is used to receive and forward information to create a bigger network that send information from one node to another. As the power and calculation ability is not same, the different Bluetooth network can use relay node to receive and forward information. [symbol] represents a low power node, which is used to decrease switching time of RF(Radio Frequency) to save power consumption by using low power features, and the low power node work together with the friend node. [symbol] represents proxy node, which is allowed to transfer and receive information between Bluetooth MESH nodes under GATT(Generic Attribute Profile) profile. The proxy node works with reliable power supply and computing resources. The attribute of the nodes can change from one to another except the proxy node, for example, the low power node is changed into a relay node. As shown in FIG. 3, the relay nodes increase, which increase the transmission of the heart message with network redundant in present Bluetooth network, and then the load of the whole Bluetooth network increase.

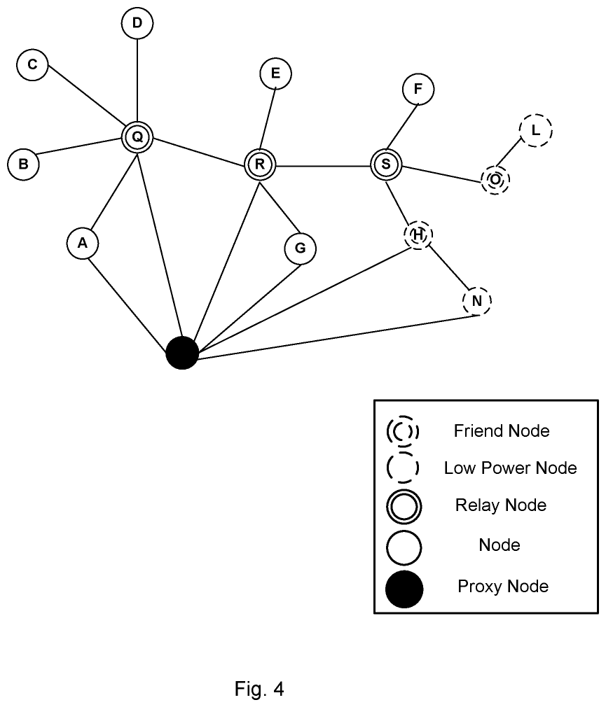

FIG. 4 shows topography of the structure of a Bluetooth network based on BLE-MESH network according to one embodiment of the present invention. After optimizing the Bluetooth network, the load of the whole Bluetooth network decrease and increase the stability of the network with the decrease of the network redundant. Comparing with the Bluetooth network in FIG. 3, the number of the relay node in FIG. 4 is less than the relay node in FIG. 3, and all nodes in FIG. 4 can be covered by relay nodes, and the all the relay nodes in FIG. 4 are connected.

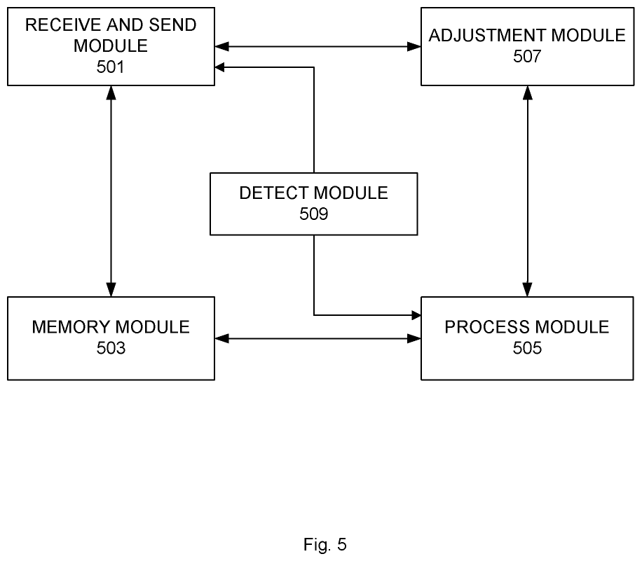

FIG. 5 shows a block diagram of a system based on BLE-MESH network according to one embodiment of the present invention. FIG. 5 will be described in combination with FIG. 1. As shown in FIG. 5, the BLE-MESH network system includes a receive and send module 501, a memory module 502, a process module 505, a adjustment module 507 and a detect module 509. The receive and send module 501 is configured to send and receive heartbeat message of the node, and data conversion. The memory module 502 is configured to store network structured database and collect network structure information. The process module 505 is configured to calculate network configuration plan according to the heartbeat message. The adjustment module 507 is configured to correct the address and attribute information which is needed to be revised according to the network configuration plan, and send the revised address and attribute information to nodes for correcting accordingly. The adjustment module can be radio frequency devices, simply as RF devices, and is used for switching. The detect module 509 detects if the network configure plan satisfies criteria of the best network configuration plan. And the detect module can be a MCU, microcontroller or Microcontroller Unit and is used to correct address and attribute information. If the current network configuration plan has reached to the criteria of the best network configuration plan, the BLE-MESH network system stops Bluetooth networking operations, if not, the BLE-MESH network system will continue to perform the steps in FIG. 1.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

1. A method of Bluetooth networking based on BLE-MESH Bluetooth network, comprising:
a first Bluetooth device node in a Bluetooth network comprising a plurality of Bluetooth device nodes sending heartbeat message of the first Bluetooth device node to a second Bluetooth device node in the Bluetooth network and different from the first Bluetooth device node, wherein said heartbeat message of the first Bluetooth device node includes an address and an attribute information of the first Bluetooth device;
the second Bluetooth device node sending the address and the attribute information of the first Bluetooth device node to an intelligent platform different from the first Bluetooth device node and the second Bluetooth device node;
the intelligent platform calculating a configuration plan of the Bluetooth network according to the address and the attribute information of the first Bluetooth device node and obtaining a network configuration information adjustment according to the configuration plan; and
the intelligent platform delivering a network configuration information adjustment to at least one Bluetooth device node in the Bluetooth network of which a network configuration is adjusted according to the configuration plan.

2. The method of claim 1, further comprising:
detecting the number of relay node in the configuration plan, obtaining a first configuration plan of the Bluetooth network when the number of the relay node remains the same within two successive configuration plans.

3. The method of claim 1, further comprising:
detecting address and attribute information of the plurality of Bluetooth device nodes which is connected directly with the first Bluetooth device node based on the heartbeat message of the first Bluetooth device node.

4. The method of claim 3, further comprising:
constructing a whole network structural database based on Web-links forms, wherein the Web-links forms is formed by heartbeat message information of each of the plurality of Bluetooth device nodes.

5. The method of claim 1, further comprising:
training topological structure samples of the Bluetooth network by using deep neural network models, extracting topological structure prediction models of the Bluetooth network.

6. The method of claim 1, further comprising:
receiving and forwarding information between the plurality of Bluetooth device nodes by relay nodes, wherein the relay nodes is a type of Bluetooth device node.

7. The method of claim 5, further comprising: wherein topological structure samples of the Bluetooth network satisfies that all of the plurality of Bluetooth device nodes is covered by relay nodes, and all of the relay nodes are connected directly or indirectly.

8. An intelligent networking system based on BLE-MESH Bluetooth network, comprising:
a receiving and sending module, configured to send and receive heartbeat message between a plurality of Bluetooth device nodes including a first Bluetooth device node and a second Bluetooth device node different from the first Bluetooth device node;
a process module, configured to calculate a configuration plan of a Bluetooth network based on the heartbeat message;
a detection module, configured to detect if the configuration plan of the Bluetooth network is a first configuration plan of the Bluetooth network; and
an adjustment module, configured to deliver a network configuration information adjustment to at least one of the plurality of Bluetooth device nodes of which a network configuration is adjusted according to the first configuration plan of the Bluetooth network,
wherein, said receiving and sending module of the second Bluetooth device node of the plurality of Bluetooth device nodes is further configured to sending the address and the attribute information of the first Bluetooth device node of the plurality of Bluetooth device nodes to the process module.

9. The intelligent networking system of claim 8, further comprising:
a memory module, configured to collect and store heartbeat message information of the each of the Bluetooth device nodes, and Web-links forms which is formed by heartbeat message information of each of the Bluetooth device nodes,
wherein the Web-links forms construct a whole network structural database.

10. The intelligent networking system of claim 8, wherein the process module trains topological structure samples of the Bluetooth network by using deep neural network models, extracts topological structure prediction models of the Bluetooth network.

11. The intelligent networking system of claim 8, wherein the heartbeat message of the first Bluetooth device node of the plurality of device nodes detects address and attribute information of at least one of the plurality of Bluetooth device nodes which is connected directly with the first Bluetooth device node.

12. The intelligent networking system of claim 11, wherein topological structure samples of the Bluetooth network satisfies that all of the Bluetooth device nodes is covered by relay nodes, and all of the relay nodes are connected directly or indirectly.

13. The intelligent networking system of claim 12, wherein the relay node is configured to receive and forward information between the Bluetooth device nodes.

14. The method of claim 1, further comprising:
the second Bluetooth device node sending heartbeat message of the second Bluetooth device node to the first Bluetooth device node, wherein said heartbeat message of the second Bluetooth device node includes address and attribute information of the second Bluetooth device;
the first Bluetooth device node receiving the heartbeat message of the second Bluetooth device node; and
the first Bluetooth device node sending the heartbeat message of the second Bluetooth device node to the process module,
wherein the intelligent platform calculates the configuration plan of the Bluetooth network further according to the heartbeat message of the second Bluetooth device node.

15. The intelligent networking system of claim 8, wherein said receiving and sending module of the first Bluetooth device node of the plurality of Bluetooth device nodes is further configured to sending the address and the attribute information of the second Bluetooth device node of the plurality of Bluetooth device nodes to the process module.
